(19) United States
(12) Patent Application Publication
(10) Pub. No.: US 2026/0316326 A1
(43) Pub. Date: Oct. 15, 2026

(54) EQUIPMENT FOR RESINATING WOODEN MATERIAL

(71) Applicant: IMAL S.r.l., Modena (MO) (IT)

(72) Inventor: Paolo BENEDETTI, Modena (MO) (IT)

(73) Assignee: IMAL S.r.l., Modena (MO) (IT)

(21) Appl. No.: 19/646,714

(22) Filed: Apr. 14, 2026

(30) Foreign Application Priority Data
Apr. 14, 2025 (IT) 102025000008286

(51) Int. Cl. B27N 1/02

(52) U.S. Cl. CPC B27N 1/02

(57) ABSTRACT

Equipment for resinating wooden material including a feeding device/equipment/apparatus/member/assembly/unit/portion or the like adapted to transport a base material including at least wooden fibers and/or flakes; at least one mixing assembly adapted to receive said base material from said feeding device/equipment/apparatus/member/assembly/unit/portion or the like and provided with at least one base framework and with a dispensing device/equipment/apparatus/member/assembly/unit/portion or the like associated with the base framework and adapted to dispense at least one binding agent onto the base material; and at least one resinating assembly adapted to receive the base material admixed with the binding agent from the mixing assembly to obtain a homogeneous mixture. The mixing assembly including at least one conveying body made of flexible material and non-stick to the binding agent.

### TECHNICAL FIELD

The present invention relates to a piece of equipment for resinating wooden material.

### BACKGROUND ART

In the woodworking industry, it is common to produce wooden panels by compacting loose, fibrous wooden materials admixed with a binding agent.

This particular manufacturing process yields, for example, particleboard, medium-density fiberboard (MDF), and low-density fiberboard (LDF).

Prior to the aforementioned compaction phase, a resinating process of the wooden material is carried out, which involves a mixing phase of a base wooden material with a binding agent.

The resinating process is carried out using equipment that generally comprises:
a feeding assembly;
an injection assembly that receives the wooden material to be machined, consisting of wood fibers and/or flakes, from a feeding assembly and adds one or more binding agents to this material;
a mixing assembly that receives the wooden material admixed with the binding agent from the injection assembly and mixes these components to obtain a wooden material to be compacted, having a paste-like texture, to be sent to a subsequent pressing phase.

The mixing assembly typically comprises a mixing hopper, provided with an inlet port connected downstream of the feeding means and with an outlet port connected upstream of the resinating assembly.

Furthermore, the mixing assembly comprises dispensing means for dispensing the binding agent, positioned inside the mixing hopper and operable to spread the binding agent over the base material present inside the mixing hopper.

The use of resinating equipment of known type does, however, have certain drawbacks that are primarily due to the type of binding agent used, which has a very high adhesive strength and, once dried, is difficult to remove from the surfaces on which it settles.

Since the binding agent is sprayed inside the mixing hopper, a part thereof does not intercept the base wooden material and instead settles on the walls of the hopper itself.

It is apparent that the presence of encrustations and/or settlements of binding agent on the walls of the hopper can gradually have a negative impact on the mixing process.

This necessitates the rapid and frequent removal of binding agent settlements from the hopper walls, thus causing the hopper to be opened and consequently halting the entire production process.

### DESCRIPTION OF THE INVENTION

The main aim of the present invention is to devise a piece of equipment for resinating wooden material that allows for the avoidance, or at least the reduction, of machine downtime caused by maintenance operations aimed at cleaning the mixing assembly of dried binding agent residues.

Within this aim, one object of the present invention is therefore to improve the performance of the resinating equipment and to reduce maintenance costs.

Another object of the present invention is to devise a piece of equipment for resinating wooden material that allows the aforementioned drawbacks of the prior art to be overcome through a simple, rational, easy and effective to use, as well as affordable solution.

The aforementioned objects are achieved by the present piece of equipment for resinating wooden material having the characteristics of claim 1.

### BRIEF DESCRIPTION OF THE DRAWINGS

Further characteristics and advantages of the present invention will become more apparent from the description of a preferred, but not exclusive, embodiment of a piece of equipment for resinating wooden material, illustrated by way of an indicative, yet non-limiting example, in the attached drawings, wherein:

FIG. 1 is a side view of a piece of equipment according to the invention, in accordance with a first embodiment;

FIG. 2 is an axonometric sectional view of the mixing assembly according to the invention;

FIG. 3 is a partial axonometric view of a conveying body according to the invention;

FIG. 4 is a side view of the mixing assembly according to the invention;

FIG. 5 is a detailed view of the mixing assembly of FIG. 4;

FIG. 6 is a side view of a piece of equipment according to the invention, in accordance with a second embodiment.

### EMBODIMENTS OF THE INVENTION

With particular reference to these figures, reference numeral 1 globally indicates a piece of equipment for resinating wooden material.

The piece of equipment 1 comprises:
feeding means 2 adapted to transport a base material comprising at least wooden fibers and/or flakes;
at least one mixing assembly 3 adapted to receive the base material from the feeding means 2 and provided with at least one base framework 4 and with dispensing means 5 associated with the base framework 4 and adapted to dispense at least one binding agent onto the base material;
at least one resinating assembly 6 adapted to receive the base material admixed with the binding agent from the mixing assembly 3 to obtain a homogeneous mixture.

With reference to the possible embodiment shown in the figures, the feeding means 2 comprise a conveyor belt provided with an inlet zone, at which the base material is loaded, and with an outlet zone at which the base material is released and sent to the mixing assembly 3.

More specifically, the feeding means 2 are adapted to move the base material along a feeding direction extending between the inlet zone and the outlet zone.

Usefully, the feeding means 2 comprise at least one weighing device associated with the conveyor belt in the lower part and adapted to measure the weight of the base material moved by the same conveyor belt.

The dispensing means 5 are configured to dispense an amount of binding agent based on the weight of the base material detected by the weighing device.

The resinating assembly 6 is positioned at a lower level than the feeding means 2, and the mixing assembly 3 is positioned between them.

In actual facts, the base material is transferred from the feeding means 2 to the mixing assembly 3 and finally to the resinating assembly 6 by gravity.

According to the invention, the mixing assembly 3 comprises at least one conveying body 7 made of flexible material and non-stick to the binding agent.

The conveying body 7 is adapted to receive the base material from the feeding means 2 and to convey it to the resinating assembly 6.

The dispensing means 5 are configured to dispense the binding agent onto the base material falling from the feeding means 2. The base material admixed with the binding agent then passes to the conveying body 7 and, finally, to the resinating assembly 6.

The non-stick material allows preventing or at least reducing the adhesion of the binding agent to the conveying body 7. Furthermore, the fact that the conveying body 7 is also made of a flexible material ensures that any residues of the binding agent can be easily removed by simply shaking the conveying body itself. Consequently, the conveying body 7 according to the invention allows reducing the frequency of the maintenance jobs on the mixing assembly 3.

Advantageously, the conveying body 7 is made of fabric coated with a non-stick agent.

Specifically, the fabric may have a film of non-stick agent applied to the inner surface thereof.

Alternatively, the fabric may be impregnated with the non-stick agent.

Usefully, the fabric is made of at least one material selected from the list comprising: polyamide, glass fiber, carbon fiber.

Furthermore, the fabric may be a non-woven fabric or a knitted fabric.

Advantageously, the non-stick agent comprises at least one perfluorocarbon derivative.

Perfluorocarbons are carbon and fluorine-based compounds that are known to have very low coefficients of friction with respect to various materials.

Preferably, the non-stick agent is polytetrafluoroethylene.

The conveying body 7 has a substantially cone-truncated shape and comprises an inlet port 8, located at the feeding means 2, and an outlet port 9, located at the resinating assembly 6, having a smaller diameter than said inlet port 8.

The dispensing means 5 are associated with the base framework 4, on top of the conveying body 7, at the inlet port 8.

The dispensing means 5 comprise a plurality of nozzles 10 adapted to dispense the binding agent.

Usefully, the mixing assembly 3 comprises fastening means 11, 12 placed between the base framework 4 and the conveying body 7, wherein the fastening means 11, 12 are of the removable type.

The fastening means 11, 12 allow for easy installation and removal of the conveying body 7, which can be replaced in case of wear or during maintenance jobs.

Specifically, the fastening means 11, 12 comprise a plurality of eyelets 11 arranged at the inlet port 8 along a circumference, and a plurality of corresponding hangers 12 associated with the base framework 4.

The hangers 12 are of the hook type and are configured to operate in conjunction with the eyelets 11 to hold the conveying body 7.

It cannot, however, be ruled out that the fastening means 11, 12 may be of a different type.

Usefully, the fastening means 11, 12 may also comprise a further plurality of eyelets arranged at the outlet port 9, along a circumference, and a further plurality of corresponding hangers associated with the base framework 4. This allows the conveying body 7 to be held more securely in place.

Usefully, the mixing assembly 3 comprises vibration means, not shown in detail in the figures, associated with the conveying body 7 and configured to generate a vibratory motion in the conveying body 7.

The vibration means serve to generate a vibration, either of the continuous or intermittent type, so as to facilitate the detachment of any residues of dried binding agent.

In accordance with one possible embodiment, the vibration means are of the contact type.

Alternatively, the vibration means are of the contactless type.

In accordance with the embodiment shown in the figures, the mixing assembly 3 comprises a hopper body 13 associated with the base framework 4, and the conveying body 7 is arranged internally to the hopper body 13. In this case, the hopper body 13 provides support to the conveying body 7.

Alternatively, the mixing assembly 3 may lack the hopper body 13 and comprise only the conveying body 7.

As mentioned, the resinating assembly is located below the mixing assembly 3.

The resinating assembly 6 comprises at least one resinating chamber 14, adapted to receive the base material admixed with the binding agent, and a mixing device 15, arranged internally to the resinating chamber 14 and adapted to move the homogeneous mixture along a direction of forward movement D.

The resinating chamber 14 comprises an inlet portion, intended to receive the base material admixed with the binding agent coming from the conveying body 7, and an outlet portion, adapted to allow the homogeneous mixture to come out of the resinating chamber 14.

The resinating chamber 14 has a substantially elongated shape along the direction of forward movement D.

The direction of forward movement D defined by the mixing device 15 extends between the inlet portion and the outlet portion.

The resinating chamber 14 also comprises at least one bottom wall 16, 17, upon which the base material admixed with the binding agent is settled.

The mixing device 15 comprises at least one shaft 18, rotatable around a relevant axis, and at least one spiral body 19, developing around the shaft 18.

In actual facts, the mixing device 15 is of the type of a mixing screw.

The shaft 18 is substantially parallel to the direction of forward movement D.

As a result of the rotational drive of the shaft 18, the spiral body 19, which rotates locked together with the shaft itself, moves the set of base material and binding agent in a helical motion, making the resulting compound move forward along the direction of forward movement D.

In detail, the resinating chamber 14 comprises:
at least a first stretch 20 comprising at least a first bottom wall 16; and
at least a second stretch 21 located downstream of the first stretch 20 with respect to the direction of forward movement D and comprising at least a second bottom wall 17;
   wherein the distance between the shaft 18 and the first bottom wall 16 is less than the distance between the shaft 18 and the second bottom wall 17.

The base material admixed with the binding agent enters the resinating chamber 14 through the relevant inlet portion and settles on the first bottom wall 16, progressively filling the first stretch 20 and covering the shaft 18.

The fact of positioning the shaft 18 at a distance from the first bottom wall 16 that is shorter than the distance from the second bottom wall 17 causes the amount of material needed to cover the shaft 18 to be less in the first stretch 20 than in the second stretch 21. In other words, the shorter distance between the shaft 18 and the first bottom wall 16 compared to the second bottom wall 17 causes the material coming from the mixing assembly 3 to quickly cover the shaft 18, thus coating it.

The material which covers the shaft 18 at the first stretch 20 thus allows preventing the portion thereof facing the outlet port 9 from being exposed to the falling of the binding agent, which is thereby settled directly onto the base material rather than onto the shaft 18.

In other words, the piece of equipment 1 according to the invention causes the material coming from the resinating chamber 14 to accumulate rapidly on the first bottom wall 16, coating the portion of the shaft 18 facing the outlet port 9.

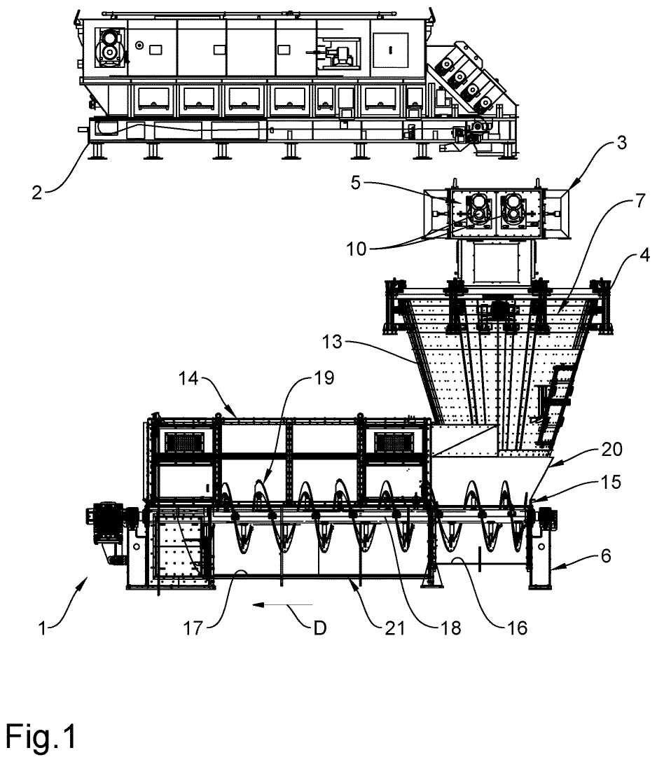

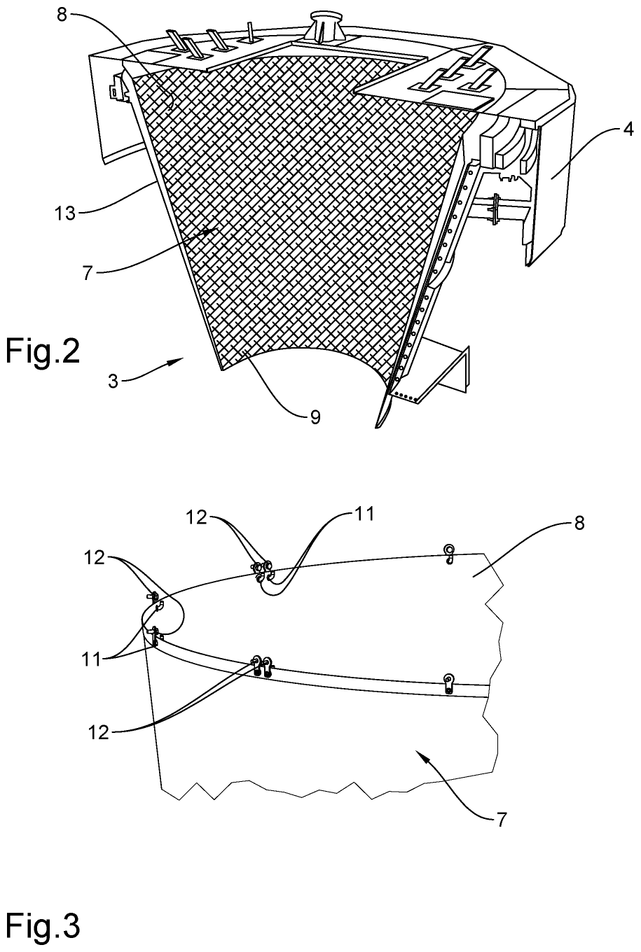

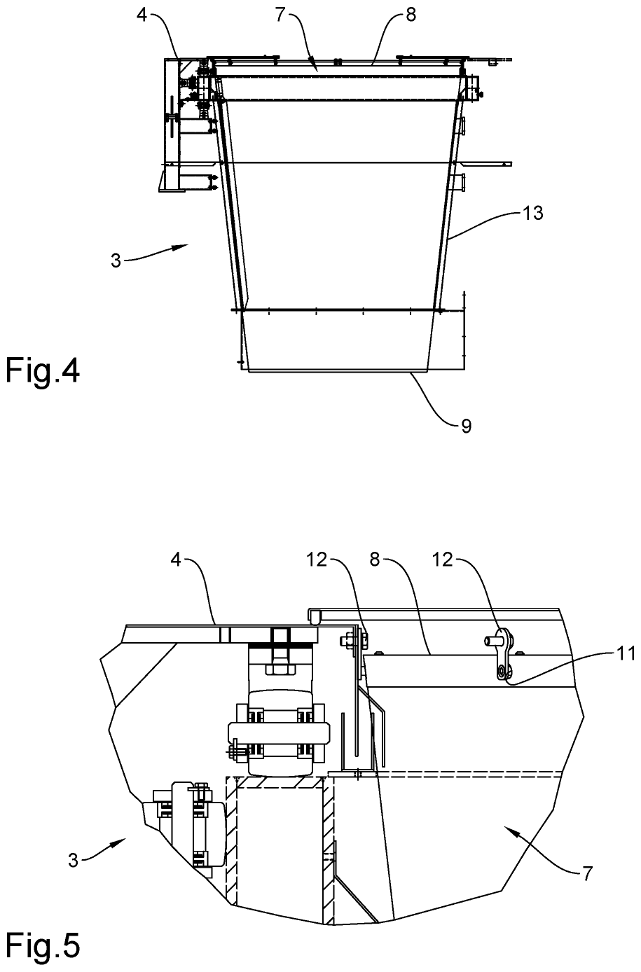

In accordance with a first embodiment shown in FIG. 1, the spiral body 19 has a substantially constant diameter along the direction of forward movement D.

Consequently, the distance between the spiral body 19 and the first bottom wall 16 is also less than the distance between the spiral body 19 and the second bottom wall 17.

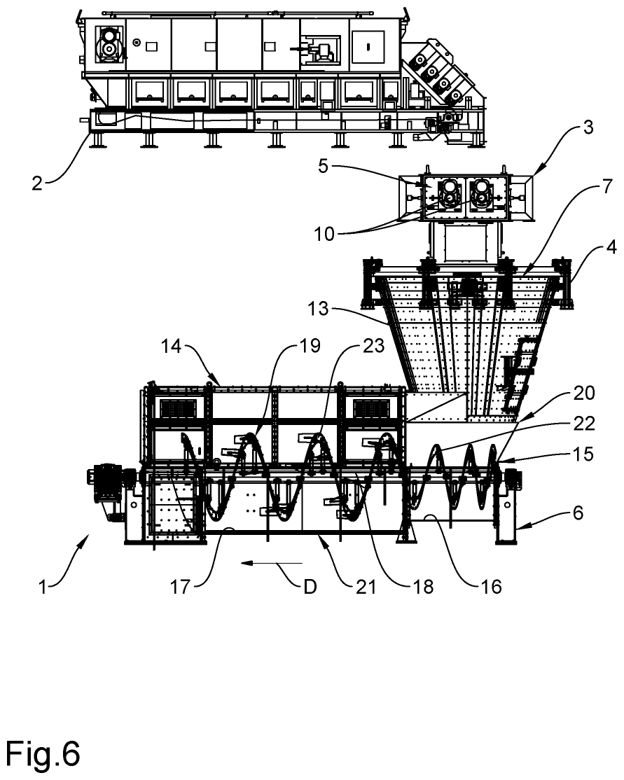

In accordance with a second embodiment shown in FIG. 6, on the other hand, the spiral body 19 comprises at least a first portion 22, arranged where the first stretch 20 is located and having a first diameter, and at least a second portion 23, arranged where the second stretch 21 is located and having a second diameter greater than the first diameter.

In this way, the spiral body 19 allows for better lifting and mixing the base material with the binding agent even in the second stretch 21.

It has in practice been ascertained that the described invention achieves the intended objects, and in particular, the fact is emphasized that the equipment for resinating wooden material makes it possible to avoid, or at least reduce, machine downtime caused by maintenance jobs aimed at cleaning the mixing assembly of residues of dried binding agent.

In fact, the presence of a conveying body made of flexible, non-stick material allows improving the performance of the resinating equipment and reducing maintenance costs.

1. An equipment for resinating wooden material, said equipment comprising:
feeding means adapted to transport a base material including at least wooden fibers and/or flakes;
at least one mixing assembly adapted to receive said base material from said feeding means and provided with at least one base framework and with dispensing means associated with said base framework and adapted to dispense at least one binding agent onto said base material; and
at least one resinating assembly adapted to receive said base material admixed with said binding agent from said mixing assembly to obtain a homogeneous mixture, wherein
said mixing assembly includes at least one conveying body made of flexible material and non-stick to said binding agent.

2. The equipment according to claim 1, wherein said conveying body is made of fabric coated with a non-stick agent.

3. The equipment according to claim 2, wherein said fabric is made of at least one material selected from the list comprising: polyamide, glass fiber, carbon fiber.

4. The equipment according to claim 2, wherein said fabric is a non-woven fabric.

5. The equipment according to claim 2, wherein said fabric is a knitted fabric.

6. The equipment according to claim 2, wherein said non-stick agent comprises at least one perfluorocarbon derivative.

7. The equipment according to claim 1, wherein said mixing assembly includes fastening means placed between said base framework and said conveying body, and said fastening means being of the removable type.

8. The equipment according to claim 1, wherein said mixing assembly includes vibration means associated with said conveying body and configured to generate vibratory motion within said conveying body.

9. The equipment according to claim 8, wherein said vibration means are of the contact type.

10. The equipment according to claim 8, wherein said vibration means are of the contactless type.

11. The equipment according to claim 1, wherein said mixing assembly comprise Includes a hopper body associated with said base framework, and said conveying body being arranged internally to said hopper body.

12. The equipment according to claim 1, wherein said resinating assembly includes at least one resinating chamber and a mixing device, arranged internally to said resinating chamber and adapted to move the homogeneous mixture along a direction of forward movement and including at least one shaft, rotatable around a relevant axis, and at least one spiral body, developing around said shaft and said resinating chamber (14) comprises:
at least a first stretch including at least a first bottom wall;
at least a second stretch located downstream of said first stretch with respect to said direction of forward movement and including at least a second bottom wall; and
the distance between said shaft and said first bottom wall is less than the distance between said shaft and said second bottom wall.

13. The equipment according to claim 12, wherein said spiral body comprises at least a first portion arranged where said first stretch is located and having a first diameter, and at least a second portion arranged where said second stretch is located and having a second diameter greater than said first diameter.
